(19) United States
(12) Patent Application Publication
(10) Pub. No.: US 2024/0233386 A9
(43) Pub. Date: Jul. 11, 2024

(54) CONGESTION DEGREE DETERMINATION APPARATUS, CONTROL METHOD, AND NON-TRANSITORY COMPUTER-READABLE MEDIUM

(71) Applicant: NEC Corporation, Minato-ku, Tokyo (JP)

(72) Inventors: Daichi SATO, Tokyo (JP); Atsushi KITAURA, Tokyo (JP); Kenichi ABE, Tokyo (JP); Xiaosu DIAO, Tokyo (JP); Daisuke KAWASAKI, Tokyo (JP); Kaori YAMANE, Tokyo (JP)

(73) Assignee: NEC Corporation, Minato-ku, Tokyo (JP)

(21) Appl. No.: 18/274,590

(22) PCT Filed: Jun. 17, 2021
(86) PCT No.: PCT/JP2021/023032

§ 371 Date: Jul. 27, 2023

(51) Int. Cl. G06V 20/52

(52) U.S. Cl. CPC G06V 20/53

(57) ABSTRACT

A congestion degree determination apparatus (2000) acquires a captured image (50) generated by an in-vehicle camera that captures an inside of a target vehicle. The congestion degree determination apparatus (2000) determines, for each of persons (30) present in the target vehicle, an area (20) in which the person (30) is positioned out of a plurality of areas (20) in the target vehicle using the captured image (50). The congestion degree determination apparatus (2000) determines the congestion degree of the target vehicle using the number of the persons (30) positioned in each of two or more of the areas (20).

### TECHNICAL FIELD

The present disclosure relates to a technique for grasping a congestion degree of vehicles.

### BACKGROUND ART

Systems have been developed for determining a congestion degree of vehicles of a train. For example, Patent Literature 1 discloses a technique to accurately compute an occupancy rate of a vehicle where the occupancy rate of the vehicle is computed with two methods using an image generated by a surveillance camera that captures an inside of the vehicle. The first method for computing the occupancy rate is a method of using a total value of areas of the inside of the vehicle that is occupied by each person. A second method for computing the occupancy rate is a method of computing a ratio between the total number of persons who board the vehicle and the maximum number of the persons who can board the vehicle.

### CITATION LIST

### Patent Literature

### Patent Literature 1

Japanese Unexamined Patent Application Publication No. 2013-025523

### SUMMARY OF INVENTION

### Technical Problem

In the method in Patent Literature 1, it is difficult to accurately determine the congestion degree of a vehicle unless all persons present in the vehicle are accurately detected. The present disclosure has been made in view of this problem, and an objective thereof is to provide a new technique for determining the congestion degree of vehicles.

### Solution to Problem

A congestion degree determination apparatus of the present disclosure includes: an acquisition unit that acquires a captured image generated by a camera which captures an inside of a target vehicle; a position determination unit that determines, for each person in the target vehicle, an area in which the person is positioned out of a plurality of areas in the target vehicle using the captured image; and a congestion degree determination unit that determines a congestion degree of the target vehicle using the number of the persons positioned in each of two or more of the areas.

A control method of the present disclosure is executed by a computer. The control method includes: an acquisition step of acquiring a captured image generated by a camera which captures an inside of a target vehicle; a position determination step of determining, for each person in the target vehicle, an area in which the person is positioned out of a plurality of areas in the target vehicle; and a congestion degree determination step of determining a congestion degree of the target vehicle using the number of the persons positioned in each of two or more of the areas.

A non-transitory computer-readable medium of the present disclosure stores a program that causes a computer to execute the control method of the present disclosure.

### Advantageous Effects of Invention

According to the present disclosure, a new technique for determining a congestion degree of vehicles is provided.

### BRIEF DESCRIPTION OF DRAWINGS

FIG. 1 is a diagram illustrating an overview of an operation of a congestion degree determination apparatus of a first example embodiment;

FIG. 2 is a block diagram illustrating a functional configuration of the congestion degree determination apparatus of the first example embodiment;

FIG. 3 is a block diagram illustrating a hardware configuration of a computer that realizes the congestion degree determination apparatus;

FIG. 4 is a flow chart illustrating a flow of processing which is executed by the congestion degree determination apparatus of the first example embodiment;

FIG. 5 is a diagram illustrating area information in a table format;

FIG. 6 is a diagram illustrating a case where an area overlapping with a person is identified as an area in which the person is positioned;

FIG. 7 is a flow chart illustrating a flow of processing for identifying a congestion degree of a target vehicle, based on the number of persons present in each area and the total number of persons detected from the captured image;

FIG. 8 is a flow chart illustrating a flow of processing for identifying the congestion degree of the target vehicle, based on the number of the persons present in each area and the total number of the persons detected from the captured image; and

FIG. 9 is a diagram illustrating congestion degree information in a table format.

### EXAMPLE EMBODIMENT

An example embodiment of the present disclosure will be described in detail below with reference to the drawings. In each drawing, the same reference numerals are given to the same or corresponding elements, and duplicate description will be omitted as appropriate for clarity of description. In addition, unless otherwise specified, values which are determined in advance such as predetermined values and thresholds are stored in advance in a memory device or the like that can be accessed from an apparatus which uses the values. Furthermore, unless otherwise specified, the memory unit is composed of an arbitrary number of one or more memory devices.

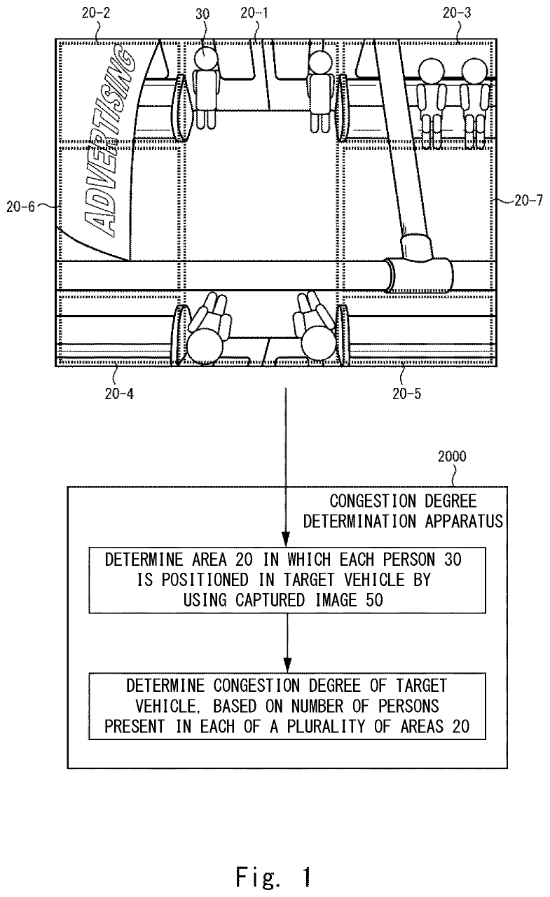

FIG. 1 illustrates an overview of an operation of a congestion degree determination apparatus 2000 of a first example embodiment. Here, FIG. 1 is a diagram for facilitating an understanding of the overview of the congestion degree determination apparatus 2000, and the operation of the congestion degree determination apparatus 2000 is not limited to the operation shown in FIG. 1.

The congestion degree determination apparatus 2000 determines a congestion degree for each of one or more vehicles of a target train. The target train is an arbitrary train for which congestion degrees of vehicles are to be determined. A vehicle whose congestion degree is to be determined is hereinafter referred to as a target vehicle. Here, each of all the vehicles constituting the target train may be handled as the target vehicle, or only a part of the vehicles constituting the target train may be handled as the target vehicle.

The congestion degree of the target vehicle is determined based on the number of persons 30 present in each of a plurality of areas 20. The area 20 is a partial region of the target vehicle: e.g., an area in front of a gate, an area of a seat, an area of an aisle, or the like. For example, in the example of FIG. 1, the target vehicle has seven areas of an area 20-1 to an area 20-7. The area 20-1 is the area in front of the gate. Each of an area 20-2 to an area 20-5 is the area of the seat. Each of an area 20-6 and the area 20-7 is the area of the aisle.

The person 30 is an arbitrary person present in the target vehicle, for example, a passenger. However, a person other than the passenger, such as a crew member riding in the target vehicle, may also be handled as the person 30.

The congestion degree determination apparatus 2000 acquires a captured image 50. The captured image 50 is generated by a camera (hereinafter referred to as an in-vehicle camera) provided in the target vehicle so as to capture an inside of the target vehicle. The in-vehicle camera is set at a relatively high position, such as a ceiling of the target vehicle, so as to look down the inside of the target vehicle.

The congestion degree determination apparatus 2000 analyzes the captured image 50, and thereby determines in which area 20 each person 30 captured by the in-vehicle camera is positioned. Furthermore, the congestion degree determination apparatus 2000 determines the number of the persons 30 present in each of two or more areas 20, and determines the congestion degree of the target vehicle based on the determined number of the persons.

In addition, it is possible that a plurality of in-vehicle cameras each of which captures different place from each other is provided in one target vehicle. Suppose that, in the example of FIG. 1, the target vehicle has four gates on the left and right sides, respectively. In this case, four in-vehicle cameras are provided in one vehicle. In such a case, the congestion degree of the target vehicle may be determined using all of the four in-vehicle cameras, or may be determined using only some of the in-vehicle cameras. Details of this point will be described later. Note that in the following description, the left and right gates will be handled as a set.

### <Example of Advantageous Effect>

According to the congestion degree determination apparatus 2000 of the present example embodiment, it is determined in which area 20 the person 30 present in the target vehicle is positioned, among the plurality of areas 20 included in the target vehicle. The congestion degree of the target vehicle is determined based on the number of the persons 30 present in each of two or more of the areas 20. In this way, according to the congestion degree determination apparatus 2000 of the present example embodiment, a new technique for determining the congestion degree of vehicles is provided.

Here, there are obstacles such as advertisements in the vehicle, and thus, it is difficult to capture all the persons in the vehicle with the in-vehicle camera. It is considered that in the method of Patent Literature 1 in which the congestion degree is determined by focusing only on the total number or the total area of persons present in the vehicle, the presence of a person who cannot be detected due to the obstacle largely affects the accuracy of the congestion degree of the vehicle.

In this regard, the congestion degree determination apparatus 2000 determines the number of the persons 30 in each area 20. Because of this, the congestion degree determination apparatus 2000 can reduce the influence of the presence of the person 30 that cannot be detected due to the obstacle on the accuracy of the congestion degree of the vehicle by a method of, for example, particularly focusing on the number of the persons 30 in an area 20 in which the influence of the obstacle is small (the area 20 in which most of the persons 30 can be captured by the in-vehicle camera).

In addition, in the congestion degree determination apparatus 2000, the congestion degree of the target vehicle is determined based on the number of the persons 30 present in each of two or more of the areas 20. In this regard, it is also possible to consider a method of determining the congestion degree of the target vehicle by focusing on only one specific area 20. However, when attention is paid to only one specific area 20, in a case where only the area 20 is congested by chance, there is a possibility that the method results in erroneously determining that the whole vehicle is congested.

For example, suppose that a vehicle having few passengers are boarded by a group of some passengers. Here, it is considered that passengers belonging to the same group as each other are usually included in the same area 20. Because of this, a situation can occur in which only the specific area 20 is congested although the vehicle is vacant as a whole.

In this regard, the congestion degree determination apparatus 2000 uses the number of the persons 30 included in each of two or more of the areas 20. Because of this, the congestion degree of the vehicle can be more accurately determined even in a case where only a specific area 20 happens to be congested, since the situation of the other areas 20 are also taken into consideration.

The congestion degree determination apparatus 2000 of the present example embodiment will be described in more detail below.

### <Example of Functional Configuration>

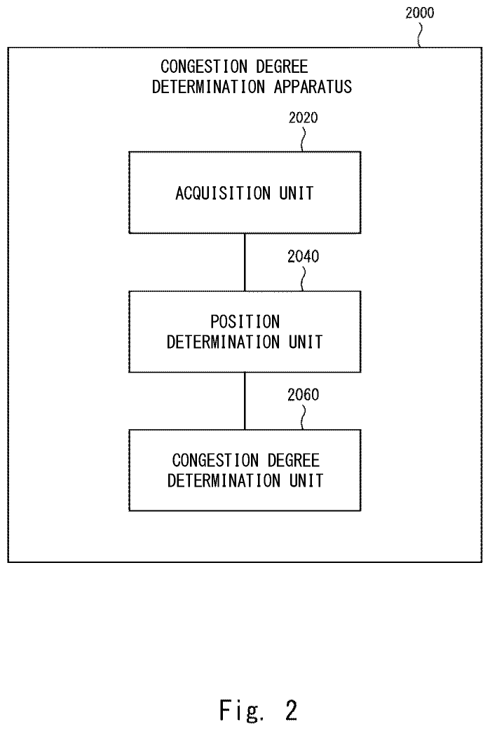

FIG. 2 is a block diagram illustrating a functional configuration of the congestion degree determination apparatus 2000 of the first example embodiment. The congestion degree determination apparatus 2000 includes an acquisition unit 2020, a position determination unit 2040, and a congestion degree determination unit 2060. The acquisition unit 2020 acquires a captured image 50. The position determination unit 2040 uses the captured image 50 to determine the area 20 in which each person 30 is positioned. The congestion degree determination unit 2060 determines, for each of two or more of the areas 20, the number of the persons 30 included in that area 20 to determine the congestion degree of the target vehicle based on that number.

### <Example of Hardware Configuration>

Each functional configuration unit of the congestion degree determination apparatus 2000 may be realized by hardware (for example, a hardwired electronic circuit or the like) which realizes each functional configuration unit, or may be realized by a combination of hardware and software (for example, a combination of an electronic circuit and a program for controlling the electronic circuit, or the like). The case will be further described below where each functional configuration unit of the congestion degree determination apparatus 2000 is realized by a combination of hardware and software.

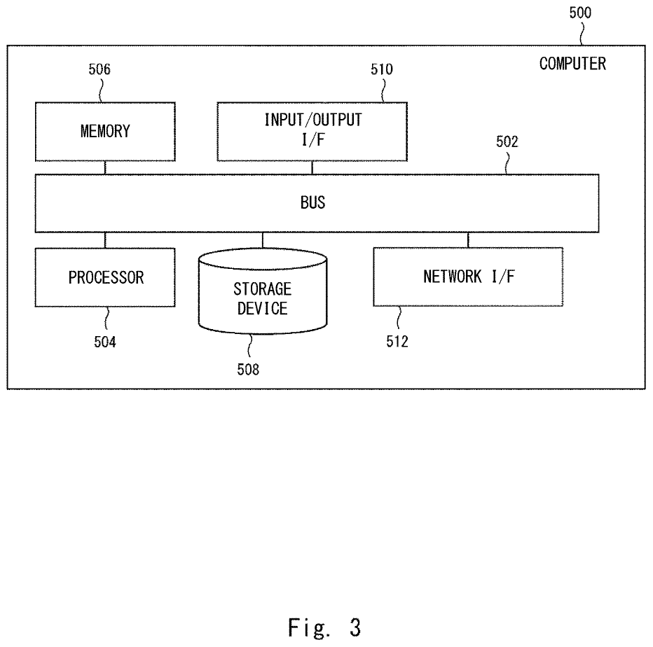

FIG. 3 is a block diagram illustrating a hardware configuration of a computer 500 that realizes the congestion degree determination apparatus 2000. The computer 500 is an arbitrary computer. For example, the computer 500 is a stationary computer such as a PC (personal computer) or a server machine. In addition, for example, the computer 500 is a portable computer such as a smart phone or a tablet terminal. The computer 500 may be a special-purpose computer that is designed in order to realize the congestion degree determination apparatus 2000, or may be a general-purpose computer.

For example, when a predetermined application is installed in the computer 500, the computer 500 thereby realizes each function of the congestion degree determination apparatus 2000. The above application is composed of a program for realizing each functional configuration unit of the congestion degree determination apparatus 2000. Note that the above program can be acquired in an arbitrary manner. For example, the computer 500 can acquire the program from a memory medium (DVD disc, USB memory, or the like) in which the program is stored. In addition, the computer 500 can acquire the program, for example, by down-loading the program from a server apparatus that manages the memory device in which the program is stored.

The computer 500 includes a bus 502, a processor 504, a memory 506, a storage device 508, an input/output interface 510, and a network interface 512. The bus 502 is a data transmission path through which the processor 504, the memory 506, the storage device 508, the input/output interface 510 and the network interface 512 transmit and receive data to and from each other. However, a method of connecting the processor 504 and the like to each other is not limited to bus connection.

The processor 504 is any of various processors such as a CPU (central processing unit), a GPU (graphics processing unit), an FPGA (field-programmable gate array) or the like. The memory 506 is a primary memory device that is realized by using a RAM (random access memory) or the like. The storage device 508 is a secondary memory device that is realized by using a hard disk, an SSD (solid state drive), a memory card, a ROM (read only memory), or the like.

The input/output interface 510 is an interface for connecting the computer 500 with an input/output device. For example, an input apparatus such as a keyboard or the like, and an output apparatus such as a display apparatus or the like are connected to the input/output interface 510.

The network interface 512 is an interface for connecting the computer 500 to a network. This network may be a LAN (local area network) or a WAN (wide area network).

The storage device 508 stores a program for realizing each functional configuration unit of the congestion degree determination apparatus 2000 (a program for realizing the above-mentioned application). The processor 504 reads out this program to the memory 506 and executes the program; and thereby realizes each functional configuration unit of the congestion degree determination apparatus 2000.

The congestion degree determination apparatus 2000 may be realized by one computer 500, or may be realized by a plurality of computers 500. In the latter case, the structures of each computer 500 need not be the same, but can be different from each other.

### <<Regarding In-Vehicle Camera>>

The in-vehicle camera repeatedly performs capturing, and thereby generates a plurality of captured images 50. It is noted that the in-vehicle camera may be a video camera that generates video data, or may be a still camera that generates a still image. In the former case, the captured image 50 is a video frame that constitutes the video data.

Some or all of the functions of the congestion degree determination apparatus 2000 may be realized by the in-vehicle camera. In this way, the camera that realizes some or all of the functions of the congestion degree determination apparatus 2000 can use a camera which is called, for example, an IP (internet protocol) camera, a network camera, an intelligent camera or the like.

In a case where a part of the functions of the congestion degree determination apparatus 2000 is realized by the in-vehicle camera, for example, the acquisition unit 2020 and the position determination unit 2040 are realized by the in-vehicle camera. In this case, the in-vehicle camera analyzes the captured image 50 generated by itself, detects the person 30 from the captured image 50, and determines in which area 20 the person 30 is positioned. The information that indicates in which area 20 each person 30 is positioned is provided to an apparatus that realizes the congestion degree determination unit 2060. This apparatus determines the congestion degree of the target vehicle.

### <Flow of Processing>

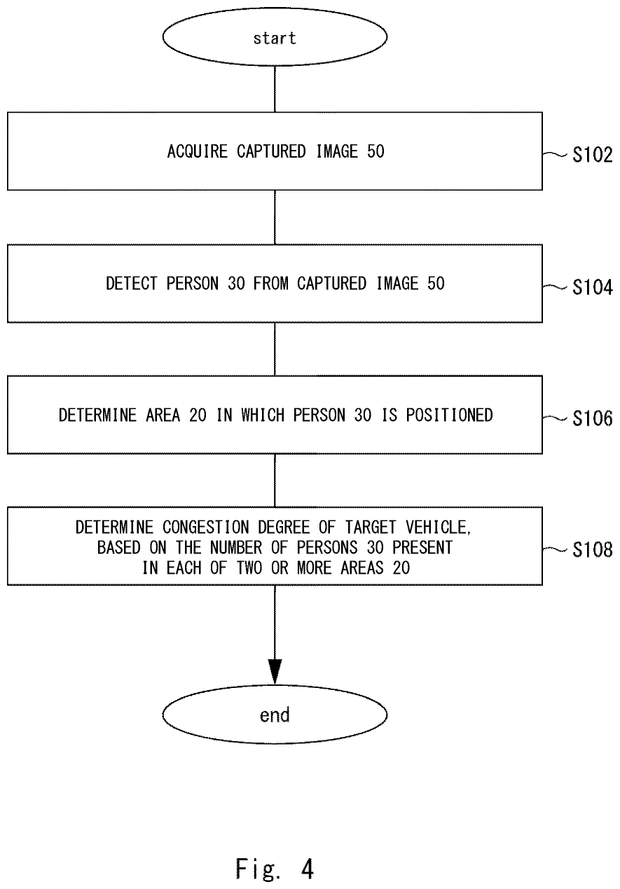

FIG. 4 is a flow chart illustrating a flow of processing which is executed by the congestion degree determination apparatus 2000 of the first example embodiment. The acquisition unit 2020 acquires the captured image 50 (S102). The position determination unit 2040 detects the person 30 from the captured image 50 (S104). For each person 30 detected from the captured image 50, the position determination unit 2040 determines the area 20 in which the person 30 is positioned (S106). The congestion degree determination unit 2060 determines the number of the persons 30 present in each of two or more of the areas 20, and determines the congestion degree of the target vehicle based on that number (S108).

### <Trigger for Determining Congestion Degree of Target Vehicle>

The congestion degree of the target vehicle can change over time. For this reason, it is preferable that the congestion degree determination apparatus 2000 repeatedly determines the congestion degree of the target vehicle (the series of the processing illustrated in FIG. 4).

There are various triggers for the congestion degree determination apparatus 2000 to determine the congestion degree of the target vehicle. For example, the congestion degree determination apparatus 2000 periodically acquires the captured image 50, and determines the congestion degree of the target vehicle by using that captured image 50. In addition, for example, the congestion degree determination apparatus 2000 acquires the captured image 50 in response to an occurrence of a specific event, and determines the congestion degree of the target vehicle by using the captured image 50.

The event which triggers the determination of the congestion degree is, for example, such an event that “the target train departs from the station”. The congestion degree of the target vehicle can greatly change when the target train stops at a station and people get on or off the target train. On the other hand, it is considered that the congestion degree of the target vehicle does not change so much while the target train is running. For this reason, it is possible to figure out the congestion degree of the target vehicle at an appropriate timing by acquiring the captured image 50 in response to the departure of the target train from the station and figuring out the congestion degree of the target vehicle using that captured image 50.

It should be noted that, immediately after the target train has left the station, people who has gotten on the target train immediately before the doors close or the like may move in the target vehicle. For this reason, the congestion degree determination apparatus 2000 may determine the congestion degree of the target vehicle after a predetermined time (for example, 30 seconds) has elapsed from the time point at which the target train has departed, instead of the time point at which the target train has departed. In this way, the congestion degree of the target vehicle is determined after the movement of the persons 30 in the target vehicle has decreased. Therefore, the congestion degree determination apparatus 2000 can determine the congestion degree of the target vehicle with higher accuracy.

### <Acquisition of Captured Image 50: S102>

The acquisition unit 2020 acquires the captured image 50 (S102). Here, there are various ways for acquiring the captured image 50. For example, the in-vehicle camera is configured to store the generated captured image 50 in a storage unit that is accessible also from the congestion degree determination apparatus 2000. In this case, the acquisition unit 2020 acquires the captured image 50 by accessing the storage unit. In addition, for example, the in-vehicle camera is configured to transmit the captured image 50 to the congestion degree determination apparatus 2000. In this case, the acquisition unit 2020 acquires the captured image 50 by receiving the captured image 50 which is transmitted by the in-vehicle camera. In addition, when the position determination unit 2040 is realized by an in-vehicle camera, the in-vehicle camera acquires the captured image 50 generated by itself.

### <Detection of Person 30: S104>

The position determination unit 2040 detects a person 30 from the captured image 50 (S104). More specifically, the position determination unit 2040 detects an image region representing the person 30 (hereinafter, referred to as a person region) from the captured image 50.

It is noted that various existing methods can be used as a method for detecting the person region from the image. For example, a feature value representing a feature of a person on an image is determined in advance, and is stored in an arbitrary storage unit in such a manner that it can be acquired by the congestion degree determination apparatus 2000. The position determination unit 2040 detects an image region having a feature value matching the above-mentioned feature value from the captured image 50, and handles each detected image region as a person region. It is noted that the feature value of the person may be a feature value of the whole body or a feature value of the characteristic part (for example, the face).

In addition, for example, the position determination unit 2040 may detect the person region from the captured image 50 using a trained model (hereinafter referred to as a person detection model). The person detection model is trained in advance so as to output the person region included in the image, in response to the input of the image. An arbitrary type of model, such as a neural network, can be used as the person detection model.

<Determination of position of person 30: S106>

For each person 30 detected from the captured image 50, the position determination unit 2040 determines in which area 20 the person 30 is positioned (S106). For example, the position determination unit 2040 determines an image region on the captured image 50 that represents each area 20. For each person 30 detected from the captured image 50, the position determination unit 2040 determines the area 20 in which the person 30 is positioned, based on the person region of the person 30 and the image region representing each area 20.

In order to determine the image region on the captured image 50 representing each area 20, for example, the position determination unit 2040 acquires information (hereinafter, referred to as area information) representing a positional relationship between the area 20 and the image region on the captured image 50. The area information is generated in advance by an administrator or the like of the congestion degree determination apparatus 2000, and is stored in an arbitrary storage unit, in a manner that it can be acquired by the congestion degree determination apparatus 2000.

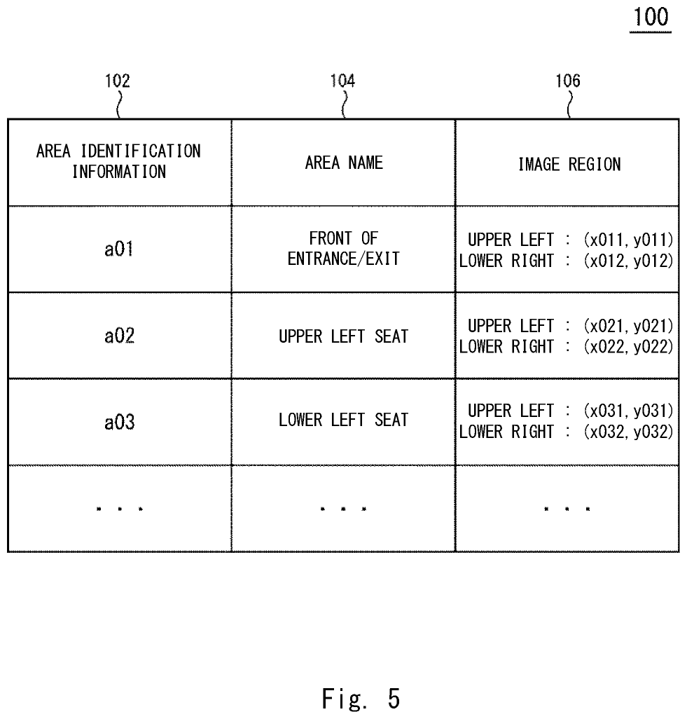

FIG. 5 is a diagram illustrating the area information in a table format. Area information 100 of FIG. 5 has three columns of area identification information 102, an area name 104, and an image region 106. The area identification information 102 indicates identification information of the area. The area name 104 indicates a name of the area. The image region 106 indicates a position of the captured image 50 to which the corresponding area 20 corresponds. For information, in this example, it is assumed that the shape of the area 20 is rectangular. For this reason, the image region 106 indicates coordinates of the upper left and lower right of the image region corresponding to the area 20.

Here, the size of the captured image 50 can vary depending on the resolution of the in-vehicle camera. For this reason, for example, the image region 106 may represent the position of the corresponding area 20 by relative coordinates on the image so that the area information 100 does not depend on the resolution of the in-vehicle camera. For example, the relative coordinates are expressed using the vertical or horizontal length of the image as a reference. As a specific example, suppose that the vertical length of the image is a reference length 1, and the image region 106 indicates “upper left: (x1, y1), and lower right: (x2, y2)”. In this case, if the vertical length of the captured image 50 is h, the image region representing the corresponding area 20 is represented by “upper left (h*x1, h*y1), and lower right (h*x2, 2*y)”, in the captured image 50.

An arrangement of each area 20 on the captured image 50 can vary depending on the type of the target vehicle. For this reason, for example, the area information 100 is prepared for each type of the vehicle. In this case, the position determination unit 2040 acquires the captured image 50 corresponding to the type of the target vehicle.

In addition, even in the captured images 50 of the same vehicle, the arrangement of the area 20 in the captured images 50 can vary depending on the position of the in-vehicle camera. For example, the arrangement of the areas 20 can be different between the captured image 50 which is generated by the in-vehicle camera provided on the ceiling near the head gate and the captured image 50 which is generated by the in-vehicle camera provided on the ceiling near the second gate from the head. For this reason, for example, the area information 100 may be prepared for each pair of the type of the vehicle and the position of the in-vehicle camera. In this case, the position determination unit 2040 acquires the area information 100 corresponding to “the type of the target vehicle and the position of the in-vehicle camera that has generated the captured image 50”.

Here, the type of the target vehicle or the position of the in-vehicle camera which has generated the captured image 50 can be determined in an arbitrary way. For example, there is an arbitrary storage unit that stores, in advance, identification information of an in-vehicle camera in association with a type of the vehicle in which the in-vehicle camera is installed and information indicating a position in the vehicle in which the in-vehicle camera is installed in a manner that they can be acquired by the congestion degree determination apparatus 2000. The position determination unit 2040 can determine the type of the target vehicle and the position of the in-vehicle camera that has generated the captured image 50 by acquiring the information that is associated with the identification information of the in-vehicle camera that has generated the captured image 50 from that storage unit.

After having determined the image region representing each area 20, the position determination unit 2040 determines the area 20 in which the person 30 is positioned for each person 30, based on the person region of the person 30 and the image region representing each area 20. For example, the position determination unit 2040 computes coordinates representing the position of the person 30 on the captured image 50 based on the person region of the person 30. The position determination unit 2040 determines an area 20 represented by the image region including those coordinates out of the areas 20, as the area 20 in which the person 30 is positioned. For example, the coordinates representing the position of the person 30 are represented by a predetermined position (for example, a center position or the like) in the person region of the person 30.

For example, suppose that the predetermined position is the center position. In this case, the position determination unit 2040 determines an area whose corresponding image region includes the center position of the person 30 out of the areas 20. The position determination unit 2040 determines that the person 30 is positioned in the determined area 20.

In addition, for example, the position determination unit 2040 determines an area whose corresponding image region overlaps with an image region representing the person 30 out of the areas 20, as the area 20 in which the person 30 is positioned. Hereinafter, in order to simplify the description, the fact that the image region representing the person 30 and the image region representing the area 20 overlap each other is also referred to as “the person 30 and the area 20 overlap each other”.

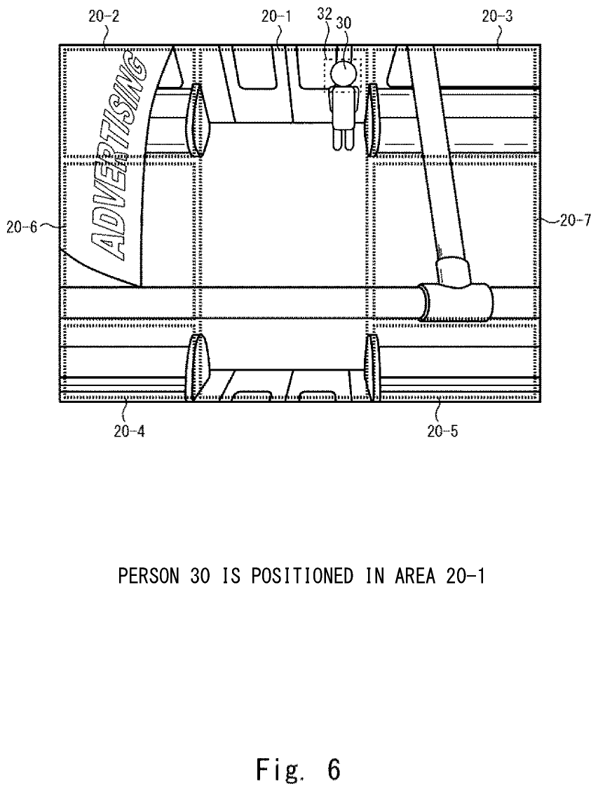

FIG. 6 is a diagram illustrating a case where the area 20 overlapping with the person 30 is determined as the area 20 in which the person 30 is positioned. In FIG. 6, a person region 32 representing the person 30 overlaps the image region representing the area 20-1. As a result, the position determination unit 2040 determines that the person 30 is positioned in the area 20-1.

Here, it is possible that the person 30 overlaps with each of a plurality of areas 20. In this case, the position determination unit 2040 determines the area 20 in which the person 30 is positioned out of the areas 20 overlapping with the person 30 based on a predetermined rule.

For example, as a predetermined rule, it is possible to adopt a rule of “the area 20 with the highest priority among the areas 20 overlapping with the person 30 is determined as the area 20 in which the person 30 is positioned”. In this case, priorities are assigned to the respective areas 20 in advance. For example, higher priorities are assigned in the order of “the area in front of the gate, the area of the back seat, the area of the front seat, and the area of the aisle”. In this case, suppose that the person region 32 overlaps with both the area 20 in front of the gate and the area 20 of the back seat, for example. In this case, the position determination unit 2040 determines that the person 30 is positioned in the area 20 in front of the gate, which has higher priority.

An example of another predetermined rule includes “determining the area 20 having the largest overlapping area with the person 30, as the area 20 in which the person 30 is positioned”. In this case, the position determination unit 2040 computes the area of the overlapping portion between the image region representing the area 20 and the person region 32, for each area 20 overlapping with the person 30. The position determination unit 2040 determines the area 20 having the largest computed area, as the area 20 in which the person 30 is positioned.

A trained model (hereinafter referred to as an area classification model) may be used for determining the area 20 in which the person 30 is positioned. The area classification model is trained in advance so as to output identification information of the area 20 in which the person 30 is positioned, in response to the input of the captured image 50 and information that specifies the person region 32 of the person 30 (for example, upper left and upper right coordinates). In this case, the position determination unit 2040 determines the area 20 in which the person 30 is positioned by using the area classification model, for each person 30 detected from the captured image 50. Here, when the area classification model is used, it is not necessary to determine the image region representing each area 20 by using the area information 100.

The area classification model is trained in advance using a plurality of pieces of training data. The training data has, for example, a pair of “a captured image obtained from an in-vehicle camera and information specifying a person region” as input data, and has a ground-truth label (identification information of the area 20) as ground-truth output data. As the area classification model, an arbitrary type of model, such as a neural network, can be used.

In addition, as mentioned above, the arrangement of the area 20 can vary depending on the type of the vehicle and the position of the in-vehicle camera (such as the head gate). For this reason, an area classification model is prepared for each pair of “the type of the vehicle and the position of the in-vehicle camera”, for example. The position determination unit 2040 inputs the captured image 50 and the position of the person region of the person 30 into the area classification model corresponding to the type of the target vehicle and the position of the in-vehicle camera (for example, “head gate”) which has generated the captured image 50. The position determination unit 2040 acquires the identification information of the area 20, which has been output from the area classification model, and determines that the person 30 is positioned in the area 20 which is identified by that identification information.

### <Determination of Congestion Degree: S108>

The congestion degree determination unit 2060 determines the congestion degree of the target vehicle, based on the number of the persons present in each of two or more of the areas 20 (S108). Some methods for determining the congestion degree of the target vehicle will be specifically exemplified below.

For example, the order of the areas 20 to be used in the determination of the congestion degree is predefined in advance. The congestion degree determination unit 2060 compares the number of the persons 30 in each of two or more of the areas 20 with a threshold in the predefined order, and determines the congestion degree of the target vehicle based on the comparison result.

Here, the congestion degree determination unit 2060 may further use the total number of the persons 30 who have been detected from the captured image 50, for the determination of the congestion degree of the target vehicle. For example, the congestion degree determination unit 2060 computes the total value of the number of persons 30 present in each of all the areas 20, and handles the total value as the total number of the persons 30. However, the congestion degree determination unit 2060 may handles the total value of the number of the persons 30 present in each of an arbitrary number of two or more of the areas 20, instead of all the areas 20, as the total number of the persons 30.

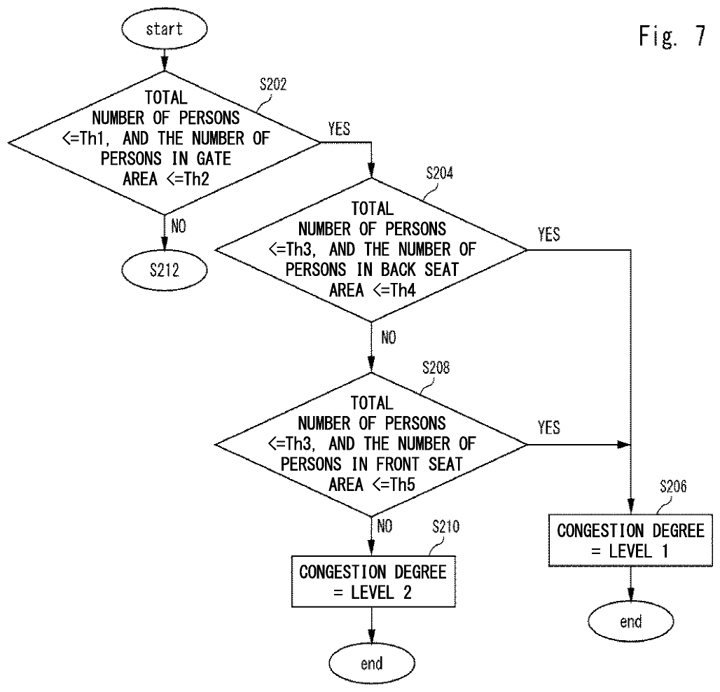

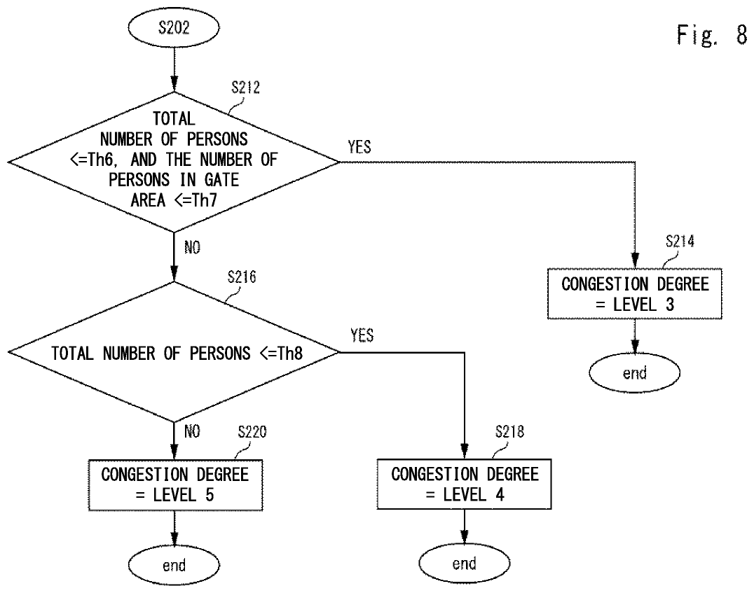

FIG. 7 and FIG. 8 are flow charts each of which illustrates a flow of processing of determining the congestion degree of the target vehicle, based on the number of the persons 30 present in each area 20 and the total number of the persons 30 detected from the captured image 50. Here, in the examples of FIG. 7 and FIG. 8, the congestion degree is classified into levels 1 to 5; the larger the numerical value of the level is, the higher the congestion degree is. Specifically, level 5 is the most congested state, and level 1 is the least congested state. In addition, the area captured by the in-vehicle camera includes seven areas 20, as illustrated in FIG. 1.

First, FIG. 7 will be explained. The congestion degree determination unit 2060 determines whether or not such a condition is satisfied that “the total number of the persons 30 detected from the captured image 50 (the total number of the persons) is equal to or smaller than a threshold Th1, and the number of the persons 30 detected from the gate area is equal to or smaller than a threshold Th2” (S202). When this condition is not satisfied (S202: NO), S212 shown by FIG. 8 is executed. FIG. 8 will be explained later.

When the condition of S202 is satisfied (S202: YES), the congestion degree determination unit 2060 determines whether or not such a condition is satisfied that “the total number of the persons is equal to or smaller than a threshold Th3, and the number of the persons in the back seat area is equal to or smaller than Th4” (S204). The threshold Th3 is defined so as to satisfy, for example, Th1>Th3. In a case where the condition of S204 is satisfied (S204: YES), the congestion degree determination unit 2060 determines that the congestion degree of the target vehicle is level 1. On the other hand, when the condition of S204 is not satisfied (S204: NO), S208 is executed.

Here, in the captured image 50 of FIG. 1, the back seat areas are two areas of the area 20-2 and an area 20-3. For the comparison with the threshold Th4, only either one of these two areas 20 may be used, or both areas may be used. In the former case, it is preferable to use one area 20 (the area 20-3 in FIG. 1), out of the two areas 20, that has fewer obstacles such as advertisements and thus with which the number of the persons therein can be more accurately determined. It is possible to, as mentioned above, set a focus on the area 20 with which the number of the persons 30 can be more accurately determined since the congestion degree determination apparatus 2000 adopts a method of dividing the target vehicle into the plurality of areas 20 and determining the number of the persons in each area 20.

Here, the position or the like of the advertisement is determined by, for example, the type of the vehicle or the position of the in-vehicle camera. For this reason, for example, which one of the area 20-2 and the area 20-3 is to be used for the comparison with the threshold Th4 is predefined in association with a pair of the type of the vehicle and the position of the in-vehicle camera. The congestion degree determination unit 2060 determines which one of the area 20-2 and the area 20-3 is to be used as the back seat area, based on the type of the target vehicle and the position of the in-vehicle camera that has generated the captured image 50.

In another example, the congestion degree determination unit 2060 may compare the number of the persons 30 present in the area 20-2 with the number of the persons 30 present in the area 20-3, and use a larger number for the comparison with the threshold Th4, for example. This is because it is considered that the more accurately the number of the persons 30 in the area 20 can be detected, the more the number of the detected persons 30 is.

Note that it is preferable to use different thresholds Th4 for a case where one of the areas 20 is used and for a case where two areas 20 are used. However, this does not apply to a case where a statistical value (an average value, the maximum value or the like) of the numbers of persons in the two areas 20 is used instead of the sum of the numbers of the persons in the two areas 20.

When the condition of S204 is not satisfied (S204: NO), the congestion degree determination unit 2060 determines whether or not such a condition is satisfied that “the total number of the persons is equal to or smaller than the threshold Th3 and the number of the persons in the front seat area is equal to or smaller than a threshold Th5” (S208). When the condition of S208 is satisfied (S208: YES), the congestion degree determination unit 2060 determines that the congestion degree of the target vehicle is level 1 (S206). On the other hand, when the condition of S208 is not satisfied (S208: NO), the congestion degree determination unit 2060 determines that the congestion degree of the target vehicle is level 2 (S210). Here, Th4 and Th5 may be set to the same value, or may be set to different values from each other.

In the captured image 50 of FIG. 1, there are two seat areas in the front seat area as well as in the back seat area. For this reason, similarly to the front seat area, either one or both of these two areas 20 may be used for comparison with the threshold Th5. In the former case, a method for determining an area to be used for the comparison with the threshold Th5 from the two front seat areas is the same as the method for determining the seat area to be used for the comparison with the threshold Th4 from the two back seat areas.

Here, in the processing flow of FIG. 7, the determination (S204) which focuses on the number of the persons in the back seat area is performed, prior to the determination (S208) which focuses on the number of the persons in the front seat area. This is because the person 30 positioned in the back seat area can be detected more accurately than the person 30 positioned in the front seat area since the face thereof is captured by the in-vehicle camera. In this way, it is possible to reduce processes performed by the congestion degree determination apparatus 2000 by first performing the determination that focuses on the area for which the accuracy of detecting the person 30 is high. It is possible to shorten a period of time required for the processing by the congestion degree determination apparatus 2000.

However, it is not an essential requirement to first perform the determination that focuses on the number of the persons in the back seat area. Thus, the order of the determination that focuses on the number of the persons in the front seat area and the determination that focuses on the number of the persons in the back seat area may be reversed from that in FIG. 7.

Next, FIG. 8 will be explained. In a case where the condition of S202 in FIG. 7 is not satisfied (S202: NO), the congestion degree determination unit 2060 determines whether or not such a condition is satisfied that “the total number of the persons is equal to or smaller than a threshold Th6 and the number of the persons 30 detected from the gate area is equal to or smaller than a threshold Th7” (S212). Here, the threshold Th6 is defined so as to satisfy, for example, Th6>Th1. In addition, the threshold Th7 is defined so as to satisfy, for example, Th7>Th2.

When the condition of S212 is satisfied (S212: YES), the congestion degree determination unit 2060 determines that the congestion degree is level 3. On the other hand, in a case where the condition of S212 is not satisfied (S212: NO), the congestion degree determination unit 2060 determines whether or not such a condition is satisfied that “the total number of the persons is equal to or smaller than a threshold Th8” (S216). Here, the threshold Th8 is defined so as to satisfy Th8>Th6, for example.

In a case where the condition of S216 is satisfied (S216: YES), the congestion degree determination unit 2060 determines that the congestion degree of the target vehicles is level 4. On the other hand, when the condition of S216 is not satisfied (S216: NO), the congestion degree determination unit 2060 determines that the congestion degree of the target vehicles is level 5 (S220).

Note that the magnitude relationship between the above-described thresholds is merely an example, and is not essential.

The method for determining the congestion degree of the target vehicle is not limited to the method of comparing the number of the persons 30 present in the area 20 with the threshold. For example, it is acceptable to compute a score which represents the congestion degree of the target vehicle (hereinafter referred to as a congestion degree score) from the number of the persons 30 present in each area 20, and determine the congestion degree of the target vehicle based on the congestion degree score. In this case, for example, a regression model is defined in advance, which computes the congestion degree score from the number of the persons 30 present in each area 20. The congestion degree determination unit 2060 can compute the congestion degree of the target vehicle by inputting the number of the persons 30 present in each area 20 to the regression model. For example, the regression model is represented by the following expression (1).

$$\begin{matrix}[ Equation 1 ] & \\ S = {\sum }_{i ∈ A} α [ i ] * N [ i ] & ( 1 )\end{matrix}$$

In the equation (1), S represents the congestion degree score is denoted by S. A set of identifiers of the area 20 existing in the target vehicle is denoted by A. An identifier of the area 20 is denoted by i. A weight assigned to an area 20 whose identifier is i (hereinafter referred to as an area i) is denoted by a[i]. The number of the persons 30 present in the area i is denoted by N[i].

The above regression model is trained in advance by using training data of “the number of the persons in each area 20 and a ground-truth congestion degree score”. Through this training, the weight a[i] is determined which is assigned to each area 20.

Here, it is considered that the weight assigned to each area 20 reflects whether or not the number of the persons 30 present in the area 20 is accurately determined. Regarding the area 20 in which it is difficult to accurately determine the number of the persons 30 therein due to obstacles such as an advertisement or the like, it is considered that the correlation between the congestion degree of the vehicle and the number of the persons 30 detected therein becomes relatively small. Thus, in the regression model which is obtained as a result of the training, the weight to be assigned to such an area 20 is considered to become relatively small. On the other hand, in the area 20 in which the number of the persons 30 can be accurately determined, it is considered that the correlation between the congestion degree of the vehicle and the number of the persons 30 therein becomes relatively large. Thus, in the regression model which is obtained as a result of the training, the weight to be assigned to such an area 20 is considered to become relatively large.

In this way, the congestion degree determination apparatus 2000 adopts a method of dividing the target vehicle into the plurality of areas 20 and determining the number of the persons for each area 20, and thereby can grasp the influence onto the congestion degree for each area 20. Thus, the congestion degree determination apparatus 2000 can more accurately determine the congestion degree of the target vehicle, as compared to a case where the congestion degree of the target vehicle is determined by focusing on the number of the persons in all the target vehicles.

Note that though the equation (1) is a linear regression model, the model of the formula of the congestion degree score is not limited to the linear regression model.

Here, the congestion degree determination unit 2060 may convert the congestion degree score into the above-mentioned congestion degree level. For example, the numerical range of the congestion degree score is divided into a plurality of partial ranges that do not overlap with each other in advance, and levels are assigned to the respective partial ranges. In this case, after the congestion degree score has been computed, the congestion degree determination unit 2060 determines the partial range in which the congestion degree score is included, and determines the congestion degree level corresponding to the determined partial range as the congestion degree level of the target vehicle.

In the above description, the congestion degree of the target vehicle is determined based on the number of the persons 30 detected from one captured image 50. However, as mentioned above, there is a case where a plurality of in-vehicle cameras is provided in the target vehicle. Thus, at a specific time point, a plurality of captured images 50 can be generated for the target vehicle. For this reason, the congestion degree determination apparatus 2000 may determine the congestion degree of the target vehicle by using captured images 50 which have been obtained from one or more of the plurality of in-vehicle cameras in the target vehicle.

For example, the congestion degree determination apparatus 2000 uses only one specific in-vehicle camera among a plurality of in-vehicle cameras provided in the target vehicle to determine the congestion degree of the target vehicle. In this case, the congestion degree of the target vehicle is determined from one captured image 50 by the above-mentioned various methods.

In addition, for example, the congestion degree determination apparatus 2000 uses the captured images 50 obtained from the plurality of in-vehicle cameras to perform the above-mentioned processing of determining the congestion degree of the target vehicle for each captured image 50, and determines a comprehensive congestion degree based on the result. Specifically, the congestion degree determination apparatus 2000 uses a statistical value (an average value, a mode value, a median value, a maximum value, a minimum value, or the like) of the congestion degree which has been determined for each captured image 50, as the comprehensive congestion degree of the target vehicle. Hereinafter, the congestion degree which is determined for each captured image 50 is also referred to as a partial congestion degree. In addition, the comprehensive congestion degree of the target vehicle, which is determined by using the partial congestion degrees that have been determined by the respective in-vehicle cameras in the target vehicle, is also referred to as a comprehensive congestion degree.

For example, suppose that there are four sets of gates in the target vehicle. Suppose that the in-vehicle cameras are provided at four places of; the vicinity of the head gate; the vicinity of the second gate from the head; the vicinity of the third gate from the head; and the vicinity of the last gate. In this case, the congestion degree determination apparatus 2000 determines the partial congestion degrees for the respective four places, and then determines the comprehensive congestion degree using a statistical value of them. In addition, when a part of the function of the congestion degree determination apparatus 2000 is realized by the in-vehicle camera, it is acceptable that each in-vehicle camera is configured to determine the partial congestion degree, and the congestion degree determination apparatus 2000 is configured to collect the results and determine the comprehensive congestion degree. An apparatus that determines the comprehensive congestion degree may be any of the in-vehicle cameras, or may be another apparatus (a server apparatus that is communicably connected to each in-vehicle camera, or the like).

In addition, the congestion degree determination apparatus 2000 may handle, for example, a set of partial congestion degrees which are determined for the target vehicle, as information representing the congestion degree of the target vehicle. In the case of the above-described example, the congestion degree determination apparatus 2000 determines the partial congestion degree for each of the four places of in-vehicle cameras, and handles a set of the determined four partial congestion degrees as the congestion degree of the target vehicle.

### <Output of Result>

The congestion degree determination apparatus 2000 generates and outputs information indicating the results of the above-mentioned various pieces of processing. The congestion degree determination apparatus 2000, for example, handles each vehicle of the target train as the target vehicle, and thereby determines the congestion degree of each vehicle of the target train. The congestion degree determination apparatus 2000 generates and outputs information which indicates the congestion degree of each vehicle of the target train (hereinafter referred to as congestion degree information). However, the congestion degree information may be generated not for all vehicles of the target train, but for only a specific vehicle.

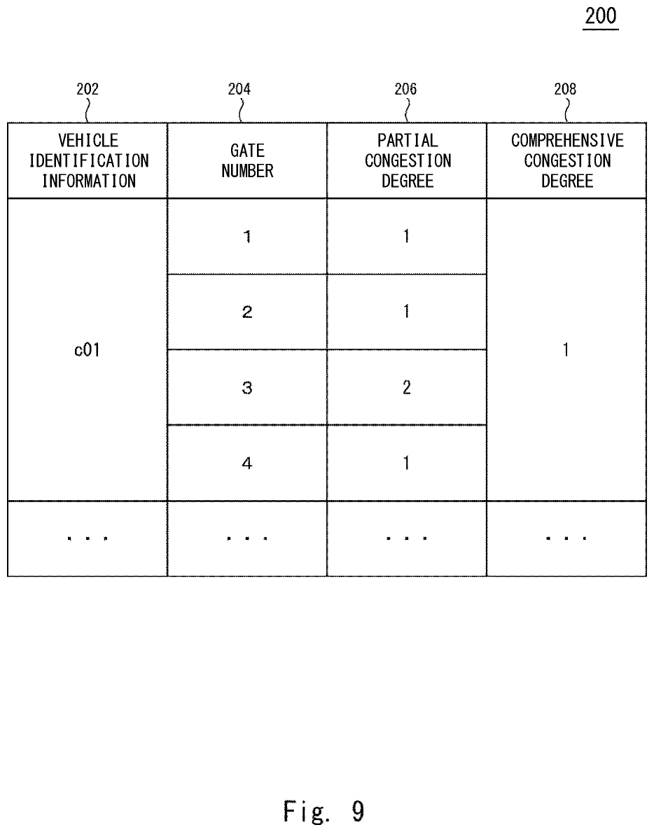

FIG. 9 is a diagram illustrating the congestion degree information in a table format. Congestion degree information 200 of FIG. 9 has four columns of vehicle identification information 202, gate identification information 204, a partial congestion degree 206, and a comprehensive congestion degree 208. The vehicle identification information 202 indicates the identification information of the vehicle. The gate number 204 indicates a number assigned to the gate. Note that in the example of FIG. 9, it is assumed that four sets of gates are provided in one vehicle, and the partial congestion degree is determined for each set. The partial congestion degree 206 indicates a partial congestion degree which are determined for the corresponding set of gates. The comprehensive congestion degree 208 indicates a comprehensive congestion degree which has determined for the corresponding vehicle.

For example, the congestion degree determination apparatus 2000 generates the congestion degree information 200 for each of a plurality of trains. In addition, the congestion degree determination apparatus 2000 generates the congestion degree information 200 on different time points for one train. For example, the congestion degree information 200 is generated at a regular timing, a timing at which the train has departed each station, or the like. For this reason, the congestion degree information 200 is output in association with the identification information of the train and the generation time point. For example, the congestion degree information 200 generated for a train R1 at a time point T1 is output in association with a pair of “train identification information=R1, and time point=T1”.

The congestion degree information 200 is output in various manner. For example, the congestion degree information 200 is put in an arbitrary storage unit. In addition, the congestion degree information 200 is, for example, displayed on an arbitrary display apparatus. In addition, the congestion degree information 200 is, for example, transmitted to an arbitrary terminal. The terminal is, for example, a terminal of a customer, a terminal of a driver, a terminal provided in a facility which manages the operation of a train, or the like. The congestion degree information 200 which has been received by the terminal is displayed on a display apparatus or the like of the terminal.

For example, a customer can know the congestion degree of the train, by designating an arbitrary train on a web page or a predetermined application on her/his terminal. The terminal of the customer transmits a request which indicates the identification information of the designated train, to the congestion degree determination apparatus 2000. The congestion degree determination apparatus 2000 which has received the request generates the congestion degree information 200 concerning the designated train, and transmits the information to the terminal of the customer. The customer browses the received congestion degree information 200, and thereby can grasp the congestion degree of the train which the customer wants to use.

For information, the congestion degree determination apparatus 2000 may generate the congestion degree information 200 at above-mentioned various timings and put the generated congestion degree information in a storage unit, instead of generating the congestion degree information 200 in response to the request from a customer. In this case, the congestion degree determination apparatus 2000 reads the congestion degree information 200 which matches the request from the customer from the storage unit, and provides the customer with the congestion degree information 200 which has been read.

Note that, it is preferable that the congestion degree information 200 is converted into a format in which information is easily grasped when browsed by the customer or the like, by using a picture, a figure, or the like. This conversion may be performed by the congestion degree determination apparatus 2000, or may be performed by each terminal that has received the congestion degree information 200.

The congestion degree information 200 does not necessarily need to be provided in real time. The congestion degree determination apparatus 2000 generates the congestion degree information 200, for example, at each of a plurality of timings once a day, for each vehicle of each train operated on the day. This result can be used, for example, for the purpose of business management by a railroad company. For example, the railroad company grasps the congestion degree of each train for each day of the week or each time slot, and can appropriately set the fare according to the day of the week or the time slot.

In the above, the present invention has been described with reference to the example embodiment, but the present invention is not limited to the above example embodiment. The configuration and details of the present invention can be variously changed in such a way that those skilled in the art can understand, within the scope of the present invention.

For information, in the above-described example, the program includes a group of instructions (or software codes) which cause a computer to perform one or more functions described in the example embodiment when the program has been read into the computer. The program may be stored in a non-transitory computer-readable medium or a tangible memory medium. By way of example, and not limitation, a computer-readable medium or a tangible memory medium includes: a random-access memory (RAM), a read-only memory (ROM), a flash memory, a solid-state drive (SSD) or another memory technology; a CD-ROM, a digital versatile disc (DVD), a Blu-ray disc (registered trademark), or another optical disc storage; and a magnetic cassette, a magnetic tape, a magnetic disk storage, or another magnetic storage device. The program may be transmitted on a transitory computer-readable medium or a communication medium. By way of example, and not limitation, a transitory computer-readable medium or a communication medium includes an electrical, optical, acoustical or another form of propagation signal.

Some or all of the above example embodiment can also be described in the following supplementary notes, but are not limited to the following.

### (Supplementary Note 1)

A congestion degree determination apparatus comprising:
an acquisition unit that acquires a captured image generated by a camera which captures an inside of a target vehicle;
a position determination unit that determines, for each person in the target vehicle, an area in which the person is positioned out of a plurality of areas in the target vehicle using the captured image; and
a congestion degree determination unit that determines a congestion degree of the target vehicle using the number of the persons positioned in each of two or more of the areas.

### (Supplementary Note 2)

The congestion degree determination apparatus according to supplementary note 1,
wherein area information is stored in a storage unit, the area information associating each of the areas with a position of an image region in the captured image that represents that area, and
wherein the position determination unit performs:
   determining the image region representing each of the areas in the captured image using the area information;
   detecting a person region representing each of the persons from the captured image; and
   determining, for each of the persons, the area whose corresponding image region includes the person region of that person as the area in which that person is positioned.

### (Supplementary Note 3)

The congestion degree determination apparatus according to supplementary note 2,
wherein priorities are assigned to a plurality of the areas, respectively, and
wherein the position determination unit determines, when there is a plurality of the areas each of whose corresponding image region includes the person region of the person, the area assigned the highest priority among that plurality of the areas as the area in which the person is positioned.

### (Supplementary Note 4)

The congestion degree determination apparatus according to supplementary note 2 or 3,
wherein the area information is stored in the storage unit for each type of vehicle, and
wherein the position determination unit uses the area information corresponding to the type of the target vehicle.

### (Supplementary Note 5)

The congestion degree determination apparatus according to any one of supplementary notes 1 to 4,
wherein the congestion degree determination unit compares a total number of the persons detected from the captured image and the number of the persons positioned in the area representing a front of a gate of the target vehicle with thresholds, respectively, and determines the congestion degree of the target vehicle based on a result of the comparison.

### (Supplementary Note 6)

The congestion degree determination apparatus according to supplementary note 5,
wherein when the total number is equal to or less than a first threshold and the number of the persons positioned in the area representing the front of the gate is equal to or less than a second threshold, the congestion degree determination unit compares the total number with a third threshold and compares the number of the persons positioned in the area representing a seat with a fourth threshold, and determines the congestion degree of the target vehicle based on a result of the comparison.

### (Supplementary Note 7)

The congestion degree determination apparatus according to any one of supplementary notes 1 to 6,
wherein when there is a plurality of the areas of the same type, the congestion degree determination unit uses the number of the persons present in the area in which the person can be detected most accurately among the plurality of the areas, for the determination of the congestion degree of the target vehicle.

### (Supplementary Note 8)

A control method executed by a computer comprising:
an acquisition step of acquiring a captured image generated by a camera which captures an inside of a target vehicle;
a position determination step of determining, for each person in the target vehicle, an area in which the person is positioned out of a plurality of areas in the target vehicle; and
a congestion degree determination step of determining a congestion degree of the target vehicle using the number of the persons positioned in each of two or more of the areas.

### (Supplementary Note 9)

The control method according to supplementary note 8,
wherein area information is stored in a storage unit, the area information associating each of the areas with a position of an image region in the captured image that represents that area; and
wherein the position determination step further includes:
   determining the image region representing each of the areas in the captured image using the area information;
   detecting a person region representing each of the persons from the captured image; and
   determining, for each of the persons, the area whose corresponding image region includes the person region of that person as the area in which that person is positioned.

### (Supplementary Note 10)

The control method according to supplementary note 9,
wherein priorities are assigned to a plurality of areas, respectively, and
wherein the position determination step further includes determining, when there is a plurality of the areas each of whose corresponding image region includes the person region of the person, the area assigned the highest priority among that plurality of the areas as the area in which the person is positioned.

### (Supplementary Note 11)

The control method according to supplementary note 9 or 10,
wherein the area information is stored in the storage unit for each type of vehicle, and
wherein the position determining step further includes using the area information corresponding to the type of the target vehicle.

### (Supplementary Note 12)

The control method according to any one of supplementary notes 8 to 11,
wherein the congestion degree determination step further includes comparing a total number of the persons detected from the captured image and the number of the persons positioned in the area representing a front of a gate of the target vehicle with thresholds, respectively, and determining the congestion degree of the target vehicle based on a result of the comparison.

### (Supplementary Note 13)

The control method according to supplementary note 12,
wherein when the total number is equal to or less than a first threshold and the number of the persons positioned in the area representing the front of the gate is equal to or less than a second threshold, the congestion degree determination step further includes comparing the total number with a third threshold and comparing the number of the persons positioned in the area representing a seat with a fourth threshold, and determining the congestion degree of the target vehicle, based on a result of the comparison.

### (Supplementary Note 14)

The control method according to any one of supplementary notes 8 to 13,
wherein when there is a plurality of the areas of the same type, the congestion degree determination step further includes using the number of the persons present in the area in which the person can be detected most accurately, among the plurality of the areas, for the determination of the congestion degree of the target vehicle.

### (Supplementary Note 15)

A non-transitory computer-readable medium storing a program that causes a computer to execute:
an acquisition step of acquiring a captured image generated by a camera which captures an inside of a target vehicle;
a position determination step of determining, for each person in the target vehicle, an area in which the person is positioned out of a plurality of areas in the target vehicle; and
a congestion degree determination step of determining a congestion degree of the target vehicle using the number of the persons positioned in each of two or more of the areas.

### (Supplementary Note 16)

The computer-readable medium according to supplementary note 15,
wherein area information is stored in a storage unit, the area information associating each of the areas with a position of an image region in the captured image that represents that area; and
wherein the position determination step further includes:
   determining the image region representing each of the areas in the captured image using the area information;
   detecting a person region representing each of the persons from the captured image; and
   determining, for each of the persons, the area whose corresponding image region includes the person region of that person as the area in which that person is positioned.

### (Supplementary Note 17)

The computer-readable medium according to supplementary note 16,
wherein priorities are assigned to a plurality of areas, respectively, and
wherein the position determination step further includes determining, when there is a plurality of the areas each of whose corresponding image region includes the person region of the person, the area assigned the highest priority among that plurality of the areas as the area in which the person is positioned.

### (Supplementary Note 18)

The computer-readable medium according to supplementary note 16 or 17,
wherein the area information is stored in the storage unit for each type of vehicle, and
wherein the position determining step further includes using the area information corresponding to the type of the target vehicle.

### (Supplementary Note 19)

The computer-readable medium according to any one of supplementary notes 15 to 18,
wherein the congestion degree determination step further includes comparing a total number of the persons detected from the captured image and the number of the persons positioned in the area representing a front of a gate of the target vehicle with thresholds, respectively, and determining the congestion degree of the target vehicle based on a result of the comparison.

### (Supplementary Note 20)

The computer-readable medium according to supplementary note 19,
wherein when the total number is equal to or less than a first threshold and the number of the persons positioned in the area representing the front of the gate is equal to or less than a second threshold, the congestion degree determination step further includes comparing the total number with a third threshold and comparing the number of the persons positioned in the area representing a seat with a fourth threshold, and determining the congestion degree of the target vehicle, based on a result of the comparison.

### (Supplementary Note 21)

The computer-readable medium according to any one of supplementary notes 15 to 20,
wherein when there is a plurality of the areas of the same type, the congestion degree determination step further includes using the number of the persons present in the area in which the person can be detected most accurately, among the plurality of the areas, for the determination of the congestion degree of the target vehicle.

### REFERENCE SIGNS LIST

20 AREA
30 PERSON
32 PERSON REGION
50 CAPTURED IMAGE
100 AREA INFORMATION
102 AREA IDENTIFICATION INFORMATION
104 AREA NAME
106 IMAGE REGION
200 CONGESTION DEGREE INFORMATION
202 VEHICLE IDENTIFICATION INFORMATION
204 GATE NUMBER
206 PARTIAL CONGESTION DEGREE
208 COMPREHENSIVE CONGESTION DEGREE
500 COMPUTER
502 BUS
504 PROCESSOR
506 MEMORY
508 STORAGE DEVICE
510 INPUT/OUTPUT INTERFACE
512 NETWORK INTERFACE
2000 CONGESTION DEGREE DETERMINATION APPARATUS
2020 ACQUISITION UNIT
2040 POSITION DETERMINATION UNIT
2060 CONGESTION DEGREE DETERMINATION UNIT

What is claimed is:

1. A congestion degree determination apparatus comprising:
at least one memory that is configured to store instructions; and
at least one processor that is configured to execute the instructions to:
acquire a captured image generated by a camera which captures an inside of a target vehicle;
determine, for each person in the target vehicle, an area in which the person is positioned out of a plurality of areas in the target vehicle using the captured image; and
determine a congestion degree of the target vehicle using the number of the persons positioned in each of two or more of the areas.

2. The congestion degree determination apparatus according to claim 1,
wherein area information is stored in a storage unit, the area information associating each of the areas with a position of an image region in the captured image that represents that area, and
wherein the determination of the position further includes:
determining the image region representing each of the areas in the captured image using the area information;
detecting a person region representing each of the persons from the captured image; and
determining, for each of the persons, the area whose corresponding image region includes the person region of that person as the area in which that person is positioned.

3. The congestion degree determination apparatus according to claim 2,
wherein priorities are assigned to a plurality of the areas, respectively, and
wherein the determination of the position further includes determining, when there is a plurality of the areas each of whose corresponding image region includes the person region of the person, the area assigned the highest priority among that plurality of the areas as the area in which the person is positioned.

4. The congestion degree determination apparatus according to claim 2,
wherein the area information is stored in the storage unit for each type of vehicle, and
wherein the determination of the position further includes using the area information corresponding to the type of the target vehicle.

5. The congestion degree determination apparatus according to claim 1,
wherein the determination of the congestion degree further includes:
comparing a total number of the persons detected from the captured image and the number of the persons positioned in the area representing a front of a gate of the target vehicle with thresholds, respectively; and
determining the congestion degree of the target vehicle based on a result of those comparison.

6. The congestion degree determination apparatus according to claim 5,
wherein the determination of the congestion degree further includes performing, when the total number is equal to or less than a first threshold and the number of the persons positioned in the area representing the front of the gate is equal to or less than a second threshold:
comparing the total number with a third threshold; and
comparing the number of the persons positioned in the area representing a seat with a fourth threshold; and
determining the congestion degree of the target vehicle based on a result of those comparison.

7. The congestion degree determination apparatus according to claim 1,
wherein when there is a plurality of the areas of the same type, the number of the persons present in the area in which the person can be detected most accurately among the plurality of the areas is used in the determination of the congestion degree of the target vehicle.

8. A control method executed by a computer comprising:
acquiring a captured image generated by a camera which captures an inside of a target vehicle;
determining, for each person in the target vehicle, an area in which the person is positioned out of a plurality of areas in the target vehicle; and
determining a congestion degree of the target vehicle using the number of the persons positioned in each of two or more of the areas.

9. The control method according to claim 8,
wherein area information is stored in a storage unit, the area information associating each of the areas with a position of an image region in the captured image that represents that area; and
wherein the determination of the position further includes:
determining the image region representing each of the areas in the captured image using the area information;
detecting a person region representing each of the persons from the captured image; and
determining, for each of the persons, the area whose corresponding image region includes the person region of that person as the area in which that person is positioned.

10. The control method according to claim 9,
wherein priorities are assigned to a plurality of areas, respectively, and
wherein the determination of the position further includes determining, when there is a plurality of the areas each of whose corresponding image region includes the person region of the person, the area assigned the highest priority among that plurality of the areas as the area in which the person is positioned.

11. The control method according to claim 9,
wherein the area information is stored in the storage unit for each type of vehicle, and
wherein the determination of the position further includes using the area information corresponding to the type of the target vehicle.

12. The control method according to claim 8,
wherein the determination of the congestion degree further includes:
comparing a total number of the persons detected from the captured image and the number of the persons positioned in the area representing a front of a gate of the target vehicle with thresholds, respectively; and
determining the congestion degree of the target vehicle based on a result of those comparison.

13. The control method according to claim 12,
wherein the determination of the congestion degree further includes performing, when the total number is equal to or less than a first threshold and the number of the persons positioned in the area representing the front of the gate is equal to or less than a second threshold:
comparing the total number with a third threshold;
comparing the number of the persons positioned in the area representing a seat with a fourth threshold; and
determining the congestion degree of the target vehicle, based on a result of those comparison.

14. The control method according to claim 8,
wherein when there is a plurality of the areas of the same type, the number of the persons present in the area in which the person can be detected most accurately, among the plurality of the areas is used in the determination of the congestion degree of the target vehicle.

15. A non-transitory computer-readable medium storing a program that causes a computer to execute:
acquiring a captured image generated by a camera which captures an inside of a target vehicle;
determining, for each person in the target vehicle, an area in which the person is positioned out of a plurality of areas in the target vehicle; and
determining a congestion degree of the target vehicle using the number of the persons positioned in each of two or more of the areas.

16. The computer-readable medium according to claim 15,
wherein area information is stored in a storage unit, the area information associating each of the areas with a position of an image region in the captured image that represents that area; and
wherein the determination of the position further includes:
determining the image region representing each of the areas in the captured image using the area information;
detecting a person region representing each of the persons from the captured image; and
determining, for each of the persons, the area whose corresponding image region includes the person region of that person as the area in which that person is positioned.

17. The computer-readable medium according to claim 16,
wherein priorities are assigned to a plurality of areas, respectively, and
wherein the determination of the position further includes determining, when there is a plurality of the areas each of whose corresponding image region includes the person region of the person, the area assigned the highest priority among that plurality of the areas as the area in which the person is positioned.

18. The computer-readable medium according to claim 16,
wherein the area information is stored in the storage unit for each type of vehicle, and
wherein the determination of the position further includes using the area information corresponding to the type of the target vehicle.

19. The computer-readable medium according to claim 15,
wherein the determination of the congestion degree further includes:
comparing a total number of the persons detected from the captured image and the number of the persons positioned in the area representing a front of a gate of the target vehicle with thresholds, respectively; and
determining the congestion degree of the target vehicle based on a result of those comparison.

20. The computer-readable medium according to claim 19,
wherein the determination of the congestion degree further includes performing, when the total number is equal to or less than a first threshold and the number of the persons positioned in the area representing the front of the gate is equal to or less than a second threshold:
comparing the total number with a third threshold;
comparing the number of the persons positioned in the area representing a seat with a fourth threshold; and
determining the congestion degree of the target vehicle, based on a result of those comparison.

21. (canceled)
